(19) United States
(12) Patent Application Publication
(10) Pub. No.: US 2002/0168016 A1
(43) Pub. Date: Nov. 14, 2002

(54) Method and apparatus for reducing peak to average power ratio in a multi-carrier modulation communication system

(76) Inventors: Xianbin Wang, Singapore (SG); Tjeng Thiang Tjhung, Singapore (SG)

Correspondence Address: COLUMBIA IP LAW GROUP, PC, 10260 SW GREENBURG ROAD, SUITE 820, PORTLAND, OR, 97223, US

(21) Appl. No.: 09/808,716

(22) Filed: Mar. 14, 2001

(51) Int. Cl. H04K 1/10; H04L 27/28

(52) U.S. Cl. 375/260

(57) ABSTRACT

Amplitude values of data samples of a multi-carrier modulation signal are provided to a normalizer (306) that determines the maximum amplitude value and divides all the amplitude values by the maximum amplitude value to produce normalized amplitude values. The normalized amplitude values are then amplified by a hybrid amplifier (307) that amplifies smaller amplitudes linearly and larger amplitudes non-linearly. This reduces amplitude variations resulting in a MCM signal having a reduced peak to average power ratio (PAPR).

### FIELD OF THE INVENTION

The present invention relates to multi-carrier modulation communication systems and more particularly to reducing the peak to average power ratio in multi-carrier modulation communication systems.

### BACKGROUND OF THE INVENTION

Multi-carrier modulation (MCM) communication systems are known by a variety of other names including orthogonal frequency division multiplexing (OFDM) and digital multi-tone (DMT), and MCM has been employed in several applications such as high definition television (HDTV), digital audio broadcasting (DAB) and digital subscriber loop (DSL) systems. A MCM signal is a summation of a number of sub-carrier signals. Consequently, the amplitude of the MCM signal has a Gaussian distribution, which has a large peak to average ratio (PAPR). A measure of the PAPR of the MCM signal can be determined as N-2 for a MCM system with N-point Fourier transformation.

FIG. 1 shows a typical MCM communication system 100 as is known in the art comprising a transmitter chain 101 and a receiver chain 102. In the transmitter chain 101, a symbol packaging and channel coding module 103 receives incoming data comprising data symbols for transmission, and provides a number [(N/2)−1] of parallel output signals to a Hermittian symmetry module 104. The Hermittian symmetry module 104 provides N signals at its output, which are received by an inverse fast Fourier transform (IFFT) module 105. It will be appreciated by those skilled in the art that employing the Hermittian symmetry module 104 allows the real part of the output from the IFFT to be obtained.

A number [(N/2)−1] of sub-carrier signals are provided by the IFFT module 105 to a parallel-to-serial converter 125, which provides a serial discrete MCM signal to a cyclic prefix adder 130. The discrete MCM signal comprises data samples, where each data sample represents an amplitude value.

The serial prefix adder 130 then adds a cyclic prefix to the data samples and provides prefixed data samples. These prefixed data samples constitute what will be referred to here as an MCM signal, and the MCM signal is provided to a digital-to-analogue converter (DAC) 115, which produces an analogue transmit signal. A radio frequency transmitter 110 then transmits the analogue transmit signal on a radio communication channel.

The receiver chain 102 comprises a radio frequency receiver 120 that retrieves a corresponding analogue receive signal from the radio communication channel, and provides the received analogue signal to an analogue-to-digital converter (ADC) 122. In response, a received digital signal is provided by the ADC 122, comprising received prefixed data samples. A cyclic prefix remover 124 removes the cyclic prefix from the received prefixed data samples, and provides received data samples to a serial-to-parallel converter 126.

The serial-to-parallel converter 126 then provides a number (N) of parallel sub-carrier signals to a fast Fourier transform module 128 that demodulates the sub-carrier signals, and produces half the number [(N/2)−1] of demodulated signals. The transmitted symbols in all the demodulated signals are individually recovered by a number [(N/2)−1] of decision devices or decoders 130. The decision devices or decoders are slicers, as known to one skilled in the art. Subsequently, the recovered symbols are provided to a decoding and symbol-to-bit unpacking module 132. The decoding and symbol-to-bit unpacking module 132 then provides output data, which is substantially similar to the incoming data received by the symbol packaging and channel coding module 103 in the transmitter chain 101, for transmission.

As will be appreciated by one skilled in the art, for an MCM signal at point 105, the amplitude values of the prefixed data samples have a relatively large variation between the peak and average amplitude values. This results in a relatively large peak to average power ratio (PAPR), as is disclosed in pages 2072-2076 of an IEEE paper by Rechard van Nee and Arnout de Wild, titled “Reducing the Peak-to-Average Power Ratio of OFDM”, presented at the 48^{th}. IEEE Vehicular Technology Conference in May 1998.

FIG. 2 shows a graph 200 of the probability density function of the MCM signal, which illustrates the wide variation between the peak and average amplitude values.

Transmitting a signal with a large PAPR poses several disadvantages. One disadvantage is the large dynamic range of the MCM signal causes radio frequency power amplifiers in the radio frequency transmitter 110 to operate in a non-linear region. When operating in the non-linear region, the radio frequency power amplifiers do not operate efficiently, since most transmission systems are peak power limited. Designing an MCM system to operate in the perfectly linear region of the amplifier implies the system operates at power levels well below the maximum power available.

In practical MCM systems, where the total number of sub carriers ranges from 100 to 8092 in a DVB system, for example, the efficiency of the radio frequency power amplifier is at best 1%. Such low efficiency limits the appeal of MCM especially in battery powered portable mobile communication systems, where the power supply of such systems is limited by the battery capacity.

Another disadvantage is that the large dynamic range of the MCM signal reduces the resolution of the digital to analogue converter (DAC) 115 in the transmitter chain 101 and the analogue to digital converter (ADC) 122 in the receiver chain 102. This is because the wide range of values that need to be accommodated has to be divided by the number of quantization steps resulting in a larger step size, which determines the resolution of the converters 115 and 120. The reduced resolution causes an increase in quantization noise, thus causing a lower signal-to-quantization noise ratio.

One known method of reducing the PAPR in a MCM signal is clipping, where the MCM signal is clipped before amplification. In the system 100 a clipping circuit (not shown) would be placed between the cyclic prefix adder 130 and the digital-to-analogue converter 115 to clip the peaks in the MCM signal. Clipping causes severe non-linear distortion to the transmitted MCM signal, which cannot be corrected in the receiver chain 102. In addition, clipping introduces clipping noise that further degrades the transmitted MCM signal.

Another method of reducing the PAPR in an MCM signal is to generate multi-carrier symbols with lower PAPR using coding. With coding, a desired data sequence is embedded in a larger data sequence, and only a subset of data sequences with low PAPR are used.

Coding requires look-up-tables for encoding and decoding, since the code words that result in low PAPR are obtained only after an exhaustive search. This may not be practical when the number of sub-carriers is large. Another disadvantage of coding is that the coding rate is inversely proportional to the number of sub-carriers, and the usable coding rate presents practical limitations in many applications.

### BRIEF SUMMARY OF THE INVENTION

The present invention seeks to provide a method and apparatus for reducing peak to average power ratio in a multi-carrier modulation communication system that overcomes, or at least reduces the abovementioned problems of the prior art.

Accordingly, in one aspect, the present invention provides a peak to average power ratio reducer for a multi-carrier modulation (MCM) communication system comprising:

a normalizer for receiving a MCM signal having a plurality of data samples, wherein the plurality of data samples represent at least a plurality of amplitude values, the normalizer for determining a maximum amplitude value from the plurality of amplitude values, and for dividing each of the plurality of amplitude values by the maximum amplitude value to produce a plurality of normalized amplitude values, and the normalizer having an output for providing a normalized MCM signal comprising a plurality of normalized data samples representing the plurality of normalized amplitude values; and

a hybrid amplifier having an input coupled to the output of the normalizer, the hybrid amplifier for receiving the plurality of normalized data samples, for comparing each of the plurality of normalized amplitude values with at least one predetermined amplitude value criteria, the hybrid amplifier for linearly amplifying the normalized amplitude values of at least some of the plurality of normalized data samples when the amplitude values of the at least some of the plurality of normalized data samples satisfy the predetermined amplitude value criteria, and the hybrid amplifier for non-linearly amplifying normalized amplitude values of some other of the plurality of normalized data samples when the normalized amplitude values of the at least some other of the plurality of normalized data samples do not satisfy the predetermined amplitude criteria, and for producing a plurality of amplified amplitude values, the hybrid amplifier having an output for providing a MCM signal comprising the plurality of amplified amplitude values.

In another aspect the present invention provides a receiver for a multi-carrier modulation (MCM) communication receiver comprising:

a hybrid amplifier having an input for receiving a PAPR reduced MCM signal, the PAPR reduced MCM signal comprising a plurality of PAPR reduced data samples, wherein each of the plurality of PAPR reduced data samples comprise an amplitude value, and the hybrid amplifier having an output for providing a PAPR restored MCM signal comprising a plurality of PAPR restored data samples, wherein each of the plurality of PAPR restored data samples comprises a restored amplitude value.

In yet another aspect the present invention provides a method for peak to average power ratio reduction for a multi-carrier modulation transmission system, the method comprising the steps of:

a) receiving a MCM signal comprising a plurality of data sample, wherein each of the plurality of data samples represent an amplitude value;

b) normalizing each of the plurality of amplitude values with respect to a maximum amplitude value of the plurality of amplitude values to produce a plurality of normalized data samples having normalized amplitude values;

c) comparing each of the normalized amplitude values with a predetermined range of amplitude values, wherein the predetermined range comprises a maximum amplitude value and a minimum amplitude value;

d) amplifying the normalized amplitude values linearly when the normalized amplitude values are within the predetermined range of amplitude values;

e) comparing the normalized amplitude values with the maximum amplitude value;

f) amplifying the normalized amplitude values non-linearly in accordance with a first non-linear function when the normalized amplitude values are greater than the maximum amplitude value;

g) comparing the normalized amplitude values with the minimum amplitude value;

h) amplifying the normalized amplitude values non-linearly in accordance with a second non-linear function when the normalized amplitude values are less than the minimum amplitude value; and

i) providing a PAPR reduced MCM signal comprising a plurality of amplified data samples representing the linearly amplified amplitude values, and the non-linearly amplified amplitude values in accordance with the first and second non-linear functions.

In still another aspect the present invention provides a method for restoring a peak to average power ratio reduced signal for a multi-carrier modulation receiving system, the method comprising the steps of:

a) receiving a PAPR reduced MCM signal comprising a plurality of PAPR reduced data samples, wherein each of the plurality of PAPR reduced data samples represent an amplified amplitude value;

b) comparing the amplified amplitude values with a predetermined range of amplitude values, wherein the predetermined range comprises a maximum amplitude value and a minimum amplitude value;

c) attenuating the amplified amplitude values linearly when the received amplified amplitude values are within the predetermined range of amplitude values;

d) comparing the amplified amplitude values with the maximum amplitude value;

e) attenuating the amplitude value of the received amplified amplitude values non-linearly in accordance with a first non-linear function when the received amplified amplitude values are greater than the maximum amplitude value;

f) comparing the amplified amplitude values with the minimum amplitude value;

g) attenuating the amplified amplitude values non-linearly in accordance with a second non-linear function when the amplified amplitude values are less than the minimum amplitude value; and

h) providing a restored MCM signal comprising a plurality of PAPR restored data samples representing the linearly attenuated amplitude values, and the non-linearly attenuated amplitude values in accordance with the first and the second non-linear functions.

### BRIEF DESCRIPTION OF THE DRAWINGS

An embodiment of the present invention will now be more fully described, by way of example, with reference to the drawings of which:

FIG. 1 shows a block diagram of a prior art MCM communication system; and

FIG. 2 shows a graph of probability density function of a MCM signal in the prior art MCM communication system in FIG. 1;

FIG. 3 shows a MCM communication system in accordance with the present invention;

FIG. 4 shows a graph of probability density function of a MCM signal in the MCM communication system in FIG. 3;

FIG. 5 shows graphical representation of signal transformation of a portion of the transmitter chain in FIG. 3;

FIG. 6 shows a portion of the transmitter chain of the MCM communication system in FIG. 3;

FIG. 7 shows a flowchart detailing the operation of the portion of the transmitter chain in FIG. 6;

FIG. 8 shows a portion of the receiver chain of the MCM communication system in FIG. 3;

FIG. 9 shows a flowchart detailing the operation of the portion of the receiver chain in FIG. 8;

FIG. 10 shows a graph illustrating the SER performance of the portion of the transmitter chain of the MCM communication system in FIG. 3; and

FIG. 11 shows a graph illustrating the spectral performance of the portion of the transmitter chain of the MCM communication system in FIG. 3.

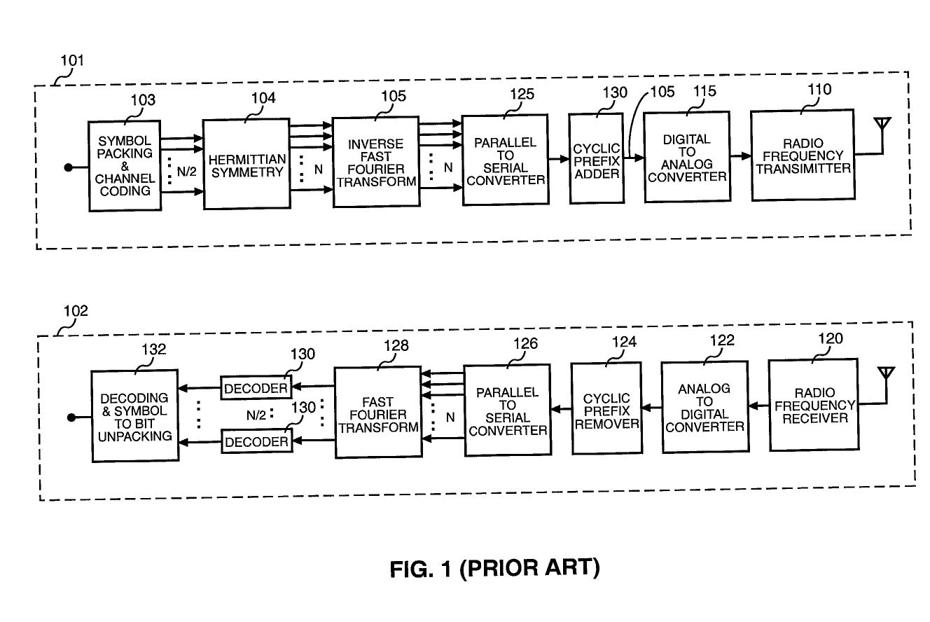

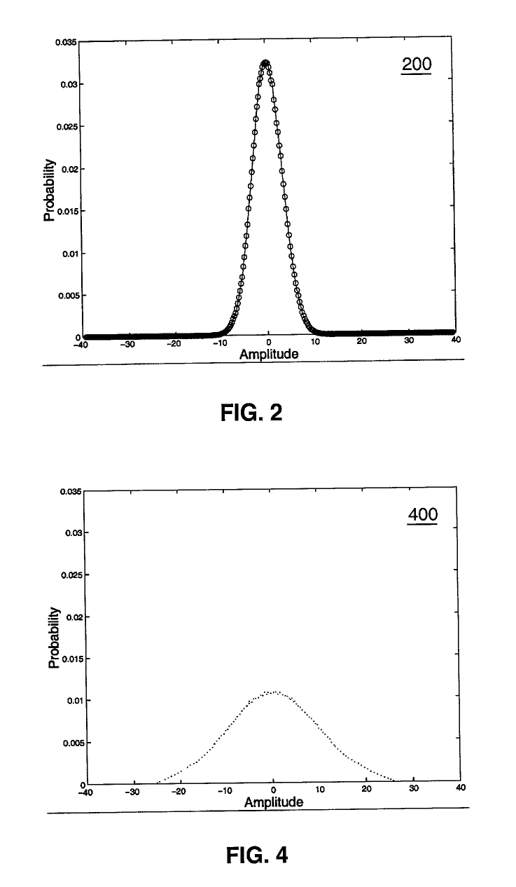

### DETAIL DESCRIPTION OF THE DRAWINGS

The present invention, as described herein, determines the peak amplitude of a digital MCM signal, normalizes the MCM signal to the peak amplitude, and then amplifies the normalized MCM signal with a hybrid amplifier. The hybrid amplifier amplifies small amplitude portions of the MCM signal linearly but it amplifies the larger amplitude portions of the MCM signal non-linearly, and to a lesser degree than the small amplitude portions. Consequently, the small amplitude portions are amplified more than the larger amplitude portions. This produces an amplified MCM signal having reduced variation between the peak amplitude and the average amplitude, thus resulting in a MCM signal with a reduced PAPR.

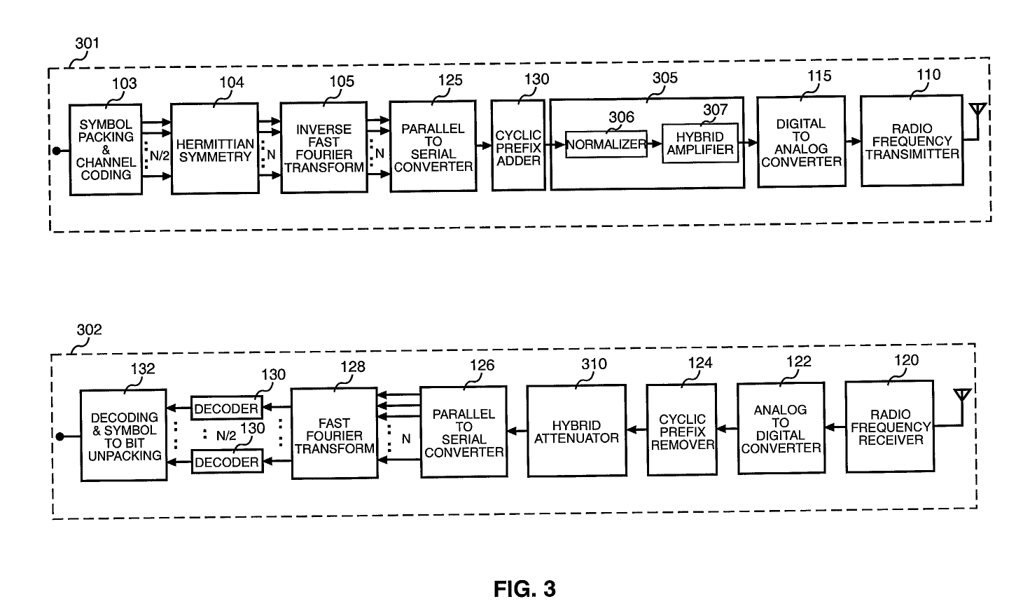

In FIG. 3 an MCM communication system 300 in accordance with the present invention has a transmitter chain 301 and a receiver chain 302. The transmitter chain 301 includes the symbol packing and channel coding module 103 that receives incoming data comprising data symbols for transmission, the Hermittian symmetry module 104, the inverse fast Fourier transform (IFFT) module 105, the parallel-to-serial converter 125, and the cyclic prefix adder 130, as described earlier.

In accordance with the present invention, the transmitter chain 301 comprises a PAPR reducer 305 that receives the data samples from the cyclic prefix adder 130 and provides prefixed data samples to the digital-to-analogue converter (DAC) 115, which produces a PAPR reduced analogue transmit signal. The PAPR reduced analogue transmit signal is received by the radio frequency transmitter 110 then transmits the PAPR reduced analogue transmit signal on a radio communication channel.

The PAPR reducer 305 comprises a normalizer 306 that determines the peak amplitude represented by the prefixed data samples, and divides the amplitudes represented by the prefixed data samples by the peak amplitude to produce normalized amplitude values represented by the normalized data samples. A hybrid amplifier 307 receives the normalized data samples and transforms the normalized amplitude values to produce transformed data samples that constitute a MCM signal with lower PAPR, which will also be referred to as a PAPR reduced MCM signal in this description.

Returning now to FIG. 3 a receiver chain 302 comprises the radio frequency receiver 120 that now retrieves a corresponding PAPR reduced analogue signal from the communication channel, and provides the PAPR reduced analogue signal to the analogue-to-digital converter (ADC) 122. The ADC 122 then provides prefixed data samples to the cyclic prefix remover 124 that removes the cyclic prefix, and provides a PAPR reduced MCM signal having PAPR reduced data samples.

In accordance with the present invention, a hybrid attenuator 310 receives the PAPR reduced MCM signal having the PAPR reduced data samples, and in response provides a PAPR restored MCM signal having restored data samples to the serial-to-parallel converter 126. The operation of the hybrid attenuator will be described later.

The serial-to-parallel converter 126, the fast Fourier transform module 128, the number [(N/2)−1] of decoders 130, and the decoding and symbol-to-bit unpacking module 132, function as described earlier, and the decoding and symbol-to-bit unpacking module 132 then provides output data, which is substantially similar to the incoming data that was received by the symbol packaging and channel coding module 103 in the transmitter for transmission.

With additional reference to FIG. 4, a graph 400 of the probability density function of the PAPR reduced MCM signal in accordance with the present invention, illustrates the significantly reduced variation between the peak and average amplitude values when compared to the graph 200.

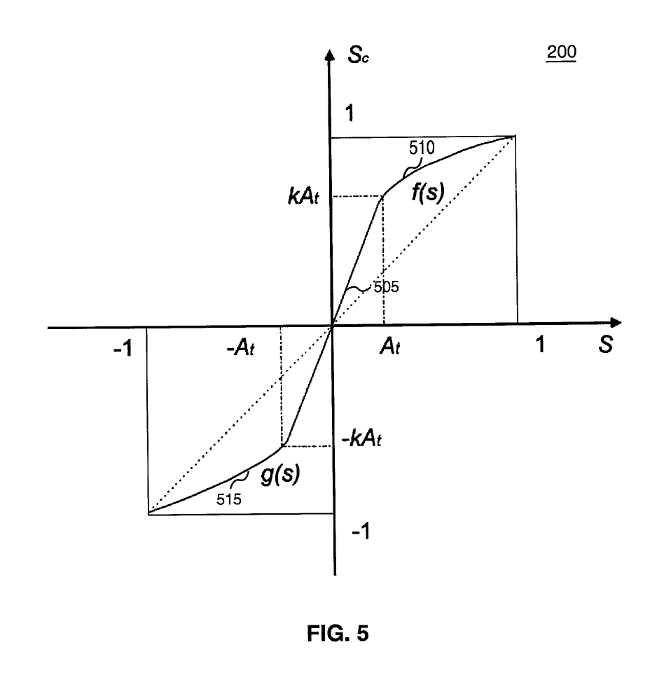

Referring to FIG. 5, the signal transformation provided by the hybrid amplifier 307 is shown graphically. The hybrid amplifier module 307 has multiple amplifiers; a linear amplifier and at least two non-linear amplifiers, and can be implemented using a digital signal processor. Amplification is performed by one of the amplifiers in the hybrid amplifier module 307 dependent on the amplitude value of the data sample that is received. When a data sample of the normalized MCM signal represents an amplitude value that is smaller than a threshold value, the linear amplifier in the hybrid amplifier module 307 operates, and when a data sample of the normalized MCM signal represents larger amplitude values, then one of the non-linear amplifiers in the hybrid amplifier 307 operates.

The hybrid amplifier 307 advantageously enhances small amplitudes instead of clipping large amplitudes of the normalized MCM signal, thereby reducing the variation in amplitude and consequently, the PAPR of the MCM signal.

The signal transformation of the hybrid amplifier 307 expressed mathematically now follows.

$${s}_{c} = \{ \begin{matrix}f ( s ) & s > {A}_{t} \\ k s & {A}_{t} \geq s \geq - {A}_{t} \\ g ( s ) & s < - {A}_{t}\end{matrix} \qquad ( 1 )$$

where,

s is the received normalized MCM signal;

Aₜ is the linear operation portion 505 of the hybrid amplifier module;

k is a constant larger than 1;

s_{c} is the new PAPR reduced MCM signal; and

f(s) and g(s) are symmetrical functions.

When the received normalized MCM signal amplitude s falls in the range of [−Aₜ, Aₜ], the hybrid amplifier 307 performs a linear transformation, amplifying the signal s by a constant k. When the amplitude of the normalized MCM signal s is larger than Aₜ, the amplitude of the normalized MCM signal s is amplified according to the non-linear functions f(s) 510 and g(s) 515. The linear portion 505 of the characteristic of the hybrid amplifier 307 prevents significant spectral distortions of the PAPR reduced MCM signal s_{c}.

With the above equation (1), the average power of the PAPR reduced MCM signal s_{c} can be estimated as,

$${E}_{{s}_{c}} = {\int }_{- ∞}^{∞} {( {s}_{c} )}^{2} \frac{1}{\sqrt{2 π } {σ}_{s}} exp ( - \frac{{s}^{2}}{2 {σ}_{s}^{2}} ) ⅆ s \qquad ( 2 )$$

To verify that s_{c}>s always holds therefore the PAPR of the PAPR reduced MCM signal is,

$${PAPR}^{′} = \frac{{A}^{2}}{{E}_{{s}_{c}}} < \frac{{A}^{2}}{{E}_{s}} = PAPR \qquad ( 3 )$$

Equation (3) indicates that the PAPR of the PAPR reduced MCM signal s_{c} is always less than the PAPR of the MCM signal s.

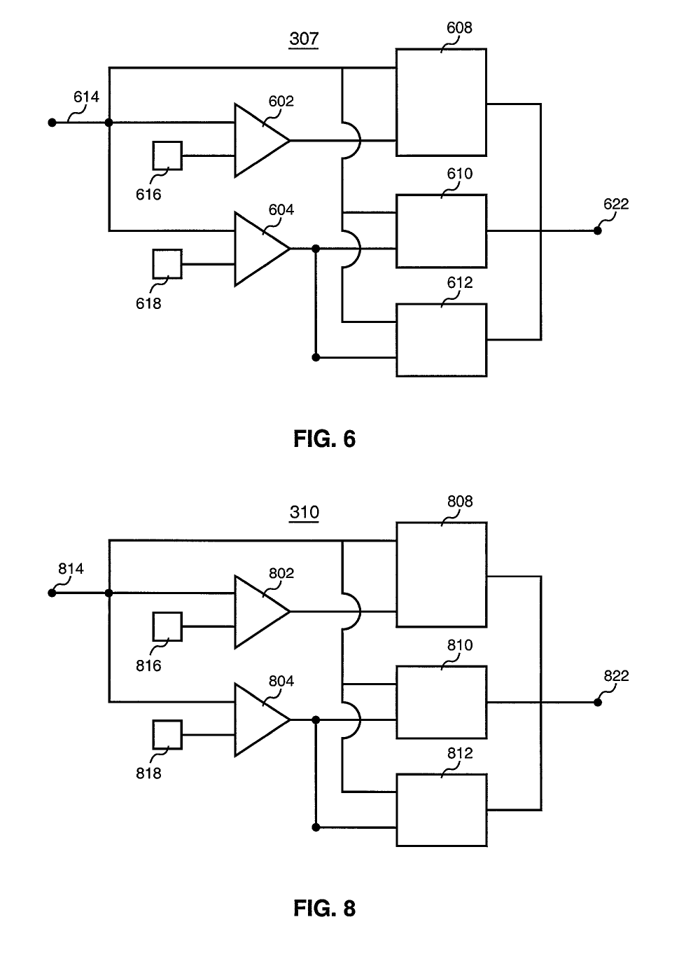

Referring to FIG. 6 the hybrid amplifier 307 comprises two digital comparators 602 and 604. The output of the first comparator 602 is coupled to a linear amplifier 608, and the output of the second comparator is coupled to non-linear amplifiers 610 and 612. An input 614 is coupled to receive the normalized MCM signal s, and is coupled to one of the inputs of each of the digital comparators 602 and 604, the input of linear amplifier 608, and the inputs of non-linear amplifiers 610 and 612. Each of a second input of the digital comparators 602 and 604 are coupled to amplitude references 616 and 618, respectively. The references 616 and 618 provide an amplitude value or a range of amplitude values. For each of the digital comparators 602 and 604 the references values are At to -At and At, respectively. The outputs of the amplifiers 608, 610 and 612 are coupled to an output 622.

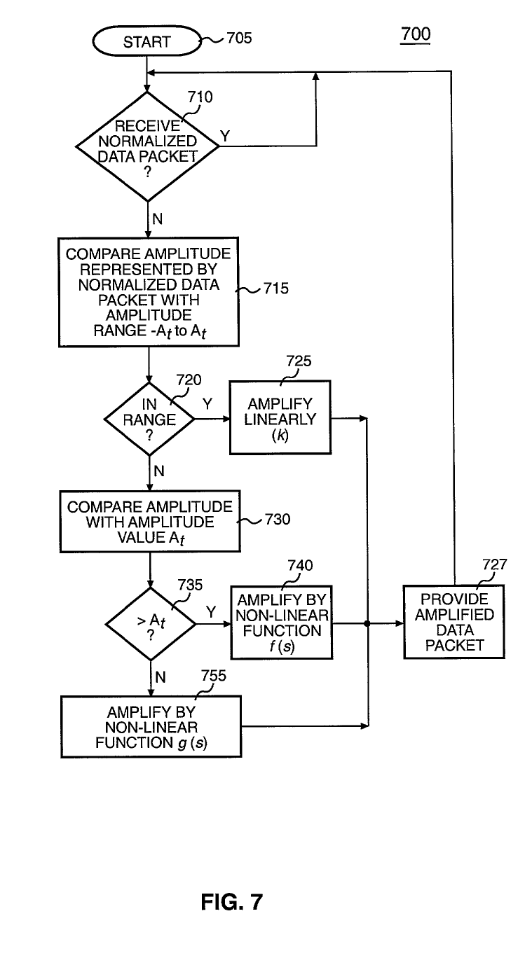

With additional reference to FIG. 7 the operation 700 of the hybrid amplifier 307 starts 705, by determining 710 whether a prefixed data sample of the normalized MCM signal is received at the input 614. When a prefixed data sample is received at the input 614, the amplitude value of the prefixed data sample is compared 715 by the first comparator 602 with the range of amplitude values Aₜ to −At.

When the amplitude value of the prefixed data sample is determined 720 to be within the range of amplitude values Aₜ to −Aₜ, the comparator 602 provides an enable signal to the linear amplifier 608. The linear amplifier 608, then amplifies 725 the amplitude value by a constant k, which is greater than 1, and provides 727 a transformed data sample having an amplified amplitude value at the output 622. The transformed data sample forms part of a PAPR reduced MCM signal. The operation 700 then returns to step 710 and repeats as described for each prefixed data sample that is received.

When the amplitude of the received prefixed data sample is determined 720 not to be within the range of amplitude values Aₜ to −Aₜ, the second comparator 604 compares 730 the amplitude value of the prefixed data sample with the threshold value At, and determines 735 whether the amplitude value is greater than the threshold value At. If it is, the second comparator 604 provides an enable signal to the non-linear amplifier 610. The non-linear amplifier 610 amplifies 740 the amplitude value of the prefixed data sample in accordance with the function f(s), and provides 727 a transformed data sample having an amplified amplitude value at the output 622. Again, the transformed data sample forms part of the PAPR reduced MCM signal, and as before, the operation 700 then returns to step 710 and repeats as described for each prefixed data sample that is received.

When the amplitude value of the received prefixed data sample is determined 735 not to be greater than the amplitude value At, the second comparator 604 provides an enable signal to the non-linear amplifier 612. The non-linear amplifier 612 amplifies 755 the amplitude value of the prefixed data sample in accordance with the function g(s), and provides 727 a transformed data sample having an amplified amplitude value at the output 622, where the transformed data sample forms part of the PAPR reduced MCM signal. And again, the operation 700 then returns to step 710 and repeats as described for each prefixed data sample that is received at the input 614.

At the receiver chain 302, as indicated earlier, the hybrid attenuator 310 receives the PAPR reduced MCM signal and provides a PAPR restored MCM signal having restored data samples. The hybrid attenuator 310 can be implemented utilizing a digital signal processor. The corresponding equation for restoration as implemented by the hybrid attenuator 310 is provided below.

$$s = \{ \begin{matrix}{f}^{′} ( {s}_{c} ) & {s}_{c} > {kA}_{t} \\ \frac{{s}_{c}}{k} & {kA}_{t} \geq {s}_{c} \geq - {kA}_{t} \\ {g}^{′} ( {s}_{c} ) & {s}_{c} < - {kA}_{t}\end{matrix} \qquad ( 4 )$$

where,

f′(s_{c}) and g′(s_{c}) are the inverted functions of functions f(s) and g(s), respectively.

With reference now to FIG. 8, the hybrid attenuator 310 comprises two digital comparators 802 and 804, the outputs of which are respectively coupled to digital linear attenuator 808, and digital non-linear attenuators 810 and 812. An input 814 is coupled to receive the PAPR reduced data samples, and is coupled to one of the inputs of each of the digital comparators 802 and 804, the input of linear attenuator 808, and the inputs of non-linear attenuators 810 and 812. Each of a second input of the digital comparators 802 and 804 are coupled to amplitude value references 816 and 818, respectively. The amplitude references 816 and 818 provide an amplitude value or a range of amplitude values that can be stored in a memory (not shown). For each of the digital comparators 802 and 804, the reference amplitude values are kAₜ to −kAₜ, and kAₜ, respectively. The outputs of the digital attenuators 808, 810 and 812 are coupled to an output 822.

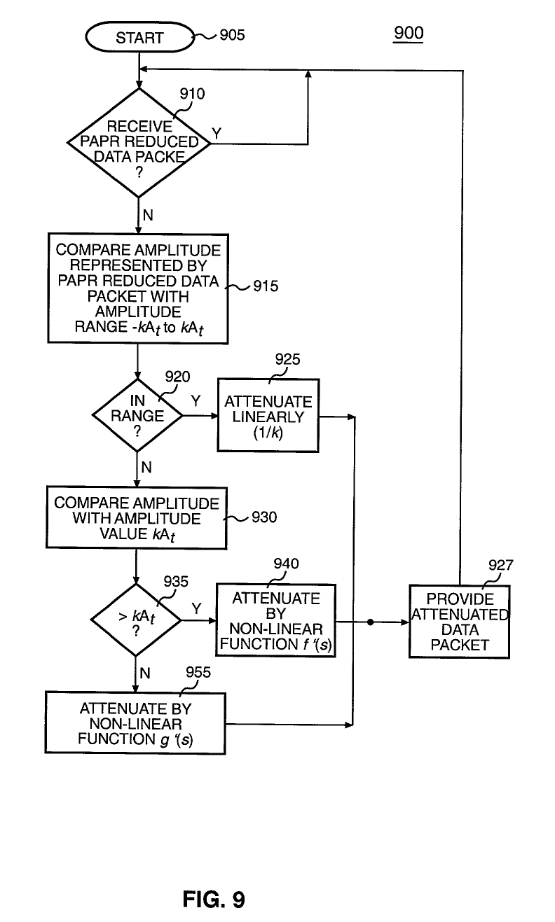

With additional reference to FIG. 9 the operation 900 of the hybrid attenuator 310 starts 905, when a determination 910 is made that a PAPR reduced data sample is received 910 at the input 814. When a PAPR reduced data sample is received, the amplitude value of the received PAPR reduced data sample is compared 915 by the first comparator 802 with the range of amplitude values kAₜ to −kAₜ. When the amplitude value of the received PAPR reduced data sample is determined 920 to be within the range of amplitude values kAₜ to −kAₜ, the comparator 802 provides an enable signal to the linear attenuator 808. The linear attenuator 808 then attenuates 925 the amplitude value of the received PAPR reduced data sample by a constant 1/k, and produces an attenuated amplitude value. The linear attenuator 808 provides 927 a PAPR restored data sample having the attenuated amplitude value at the output, where the PAPR restored data sample is a part of the PAPR restored MCM signal. The operation 900 then returns to step 910, and repeats as described for each PAPR reduced data sample that is received.

When the amplitude value of the PAPR reduced data sample is determined 920 not to be within the range of amplitude values kAₜ to −kAₜ, the second comparator 804 compares 930 the amplitude value of the received PAPR reduced data sample with the amplitude value kAt, and determines 935 whether the amplitude value of the received PAPR reduced data sample is greater than the amplitude value kA. When it is, the second comparator 804 provides an enable signal to the non-linear attenuator 810. The non-linear attenuator 810 attenuates 940 the amplitude value of the data sample in accordance with the function f′(s), and provides 927 a restored data sample having the attenuated amplitude value, to the output 822. Again, the restored data sample forms part of the PAPR restored MCM signal. Note that f′(s) is the inverse function of function f(s) described in operation 700 earlier. As before, the operation 900 then returns to step 910, and repeats as described for each PAPR reduced data sample that is received.

When the amplitude value of the PAPR reduced data sample is determined 935 not to be greater than the amplitude value kAₜ, the second comparator 804 provides an enable signal to the non-linear attenuator 812. The non-linear attenuator 812 attenuates 955 the amplitude value of the PAPR reduced data sample in accordance with the function g′(s) and provides 927 a restored data sample with the attenuated amplitude value to the output 822. As before, the restored data sample forms part of the PAPR restored MCM signal. Note that g′(s) is the inverse function of function g(s) described in operation 700 earlier. Once again, the operation 900 then returns to step 910 and repeats as described for each PAPR reduced data sample that is received.

In accordance with the present invention, by selecting different f(s) and g(s) functions of the hybrid amplifier 307, different implementations can be achieved. In any selected implementation, however, the MCM signal must first be normalized.

With reference to FIG. 3, the MCM signal data samples in real form after the IFFT module is expressed as shown below.

$$s ( n ) = \frac{2}{\sqrt{N}} {\sum }_{k = 1}^{( N / 2 ) - 1} \{ {a}_{k} cos ( \frac{2 π k n}{N} ) + {b}_{k} sin ( \frac{2 π k n}{N} ) \} , \qquad ( 5 )$$

where aₖ−jbₖ is the transmitted data for the k-th sub-carrier and N is the fast Fourier transform size of the MCM system, respectively.

From the central limit theorem, for large values of N, the samples of the MCM signal s(n) becomes Gaussian distributed. For an MCM system with N>100, this is a very accurate approximation. The variance of the MCM signal can be easily determined as follows.

$${σ}_{s}^{2} = \frac{2 ( N - 2 )}{N} {P}_{s} , \qquad ( 6 )$$

where

$${P}_{s} = E \{ \frac{1}{2} ( {a}_{k}^{2} + {b}_{k}^{2} ) \}$$

is the signal power of each sub-carrier. Based on the assumption that an MCM signal sample s(n)=u·v, where u and v are two vectors with the forms of the equation below,

$$\begin{matrix}u = ( {a}_{1} , {b}_{1} , {a}_{2} , {b}_{2} , … , {a}_{( N / 2 ) - 1} , {b}_{( N / 2 ) - 1} ) , \\ and & \text{(7-a)} \\ \begin{matrix}v = \frac{2}{\sqrt{N}} ( cos 2 π \frac{k \cdot 1}{N} , sin 2 π \frac{k \cdot 1}{N} , cos 2 π \cdot k \cdot \frac{2}{N} , sin 2 π \frac{k \cdot 2}{N} , … , \\ cos 2 π \frac{k ( - 1 + N / 2 )}{N} , sin 2 π \frac{k ( - 1 + N / 2 )}{N} ) .\end{matrix} & \text{(7-b)} \\ Thus , & \\ \vert s ( n ) \vert = \vert u \cdot v \vert \leq \vert u \vert \cdot \vert v \vert = ( N - 2 ) \sqrt{\frac{2 {P}_{s}}{N}} & ( 8 )\end{matrix}$$

Therefore, the maximum peak value of the MCM signal is

$$A = ( N - 2 ) \sqrt{\frac{2 {P}_{s}}{N}} . \qquad ( 9 )$$

From equations (6) and (9), the PAPR of the original MCM signal can also be determined as follows.

$$PAPR = \frac{{A}^{2}}{{σ}_{s}^{2}} = N - 2.$$

A particular implementation of the hybrid amplifier 307 that utilizes a logarithmic function will now be described. It will be appreciated by one skilled in the art that the hybrid amplifier 307 can also utilize a trajectory function or even a combination of the logarithmic and trajectory functions. In this implementation, the functions f(s) and g(s) are part of logarithmic functions. The PAPR reduced MCM signal can be formulated as follows.

$${s}_{c} ( n ) = \{ \begin{matrix}\frac{us ( n )}{1 + ln u} \\ \frac{A + A ln ( \frac{us ( n )}{A} )}{1 + ln u}\end{matrix} \begin{matrix}0 \leq s ( n ) \leq A / u \\ \\ A / u \leq s ( n ) \leq A\end{matrix} \qquad ( 10 )$$

where A is a constant such that

$$0 \leq \vert \frac{s ( n )}{A} \vert \leq 1 ,$$

, and u is the coefficient that determines the amplification. The complete curve must have odd symmetry such that s_{c}(s,t)=−s_{c}(|s|,t) for −A≦s≦0.

When the PAPR reduced MCM signal is transmitted, and after passing through a communication channel with additive white noise Gaussian noise (AWGN), the received signal is

r(n)=s_{c}(n)+n(n) (11)

At the receiver chain 302 of the MCM system, r(n) has to be restored to r′(n) before being sent for FFT demodulation.

$$\begin{matrix}{r}^{′} ( n ) = \{ \begin{matrix}\frac{[ {s}_{c} ( n ) + n ( n ) ] AB}{u} \\ \frac{A exp \{ [ {s}_{c} ( n ) + n ( n ) ] B - 1 \}}{u}\end{matrix} \begin{matrix}0 \leq r ( n ) \leq \frac{A}{1 + ln u} \\ \frac{A}{1 + ln u} \leq r ( n ) \leq A ,\end{matrix} \\ where , & ( 12 ) \\ B = \frac{1 + ln u}{A} . & ( 13 )\end{matrix}$$

The optimal u for the logarithmic implementation can be found by minimizing the noise component at the receiver end. Equation (12) can be rearranged as follows.

$${r}^{′} ( n ) = \{ \begin{matrix}s ( n ) + n ( n ) \frac{AB}{u} = s ( n ) + {n}_{1} ( n ) \\ s ( n ) \cdot exp [ n ( n ) B ] = s ( n ) + {n}_{2} ( n )\end{matrix} \begin{matrix}0 \leq r ( n ) \leq \frac{A}{1 + ln u} \\ \frac{A}{1 + ln u} \leq r ( n ) \leq A ,\end{matrix} \qquad ( 14 )$$

With Taylor's series, the exponential function in equation (14) can be expanded as shown below.

$$exp [ n ( n ) B ] \approx 1 + n ( n ) B + \frac{{n}^{2} ( n ) {B}^{2}}{2 !} + … \qquad ( 15 )$$

Thus the corresponding noise n₂(n) for r′(n) when A/u≦r(n)≦A after restoration can be expressed as follows,

$${n}_{2} ( n ) \approx s ( n ) {\sum }_{i = 1}^{∞} \frac{{\{ n ( n ) \}}^{i} {B}^{i}}{i !} . \qquad ( 16 )$$

Again we denote r′(n)=s(n)+n′(n), and the variances for n₁(n), n₂(n) and n′(n) are σ₁², σ₂² and σ′ₙ². Therefore, the variance of n′(n) at the receiver end is as shown below.

$$\begin{matrix}{σ}_{n}^{′2} = 2 E \{ \frac{{A}^{2} {B}^{2} {n}^{2} ( n )}{{u}^{2}} \vert 0 \leq s ( n ) \leq \frac{A}{u} \} + \\ 2 E \{ {s}^{2} ( n ) \vert \frac{A}{u} \leq s ( n ) \leq A \} {\sum }_{i = 1}^{∞} {\sum }_{{k = 1 ,}_{i + k is even}}^{∞} \frac{E \{ {n}^{i + k} \} {B}^{i + k}}{i ! k !} .\end{matrix} \qquad ( 17 )$$

where E{n^{i+k}} can be determined from the equation below.

$$E \{ {n}^{i + k} \} = E \{ {( w + q )}^{i + k} \} = {\sum }_{j = 0}^{i + k} ( \begin{matrix}j \\ i + k\end{matrix} ) {σ}_{w}^{j} {σ}_{q}^{i + k - j} . \qquad ( 18 )$$

The two expectations in the above equation can be separately evaluated.

$$\begin{matrix}\begin{matrix}{σ}_{1}^{2} = E \{ \frac{{A}^{2} {B}^{2} {n}^{2} ( n )}{{u}^{2}} \vert 0 \leq s ( n ) \leq \frac{A}{u} \} \\ = \frac{{A}^{2} {B}^{2} ( {σ}_{w}^{2} + {σ}_{q}^{2} )}{{u}^{2}} [ 0.5 - Q ( \frac{A}{u {σ}_{s}} ) ] ,\end{matrix} \\ and , & ( 19 ) \\ \begin{matrix}{σ}_{2}^{2} = E \{ {s}^{2} ( n ) \vert \frac{A}{u} \leq s ( n ) \leq A \} {\sum }_{i = 1}^{∞} {\sum }_{{k = 1 ,}_{i + k is even}}^{∞} \frac{E \{ {n}^{i + k} \} {B}^{i + k}}{i ! k !} \\ = [ \frac{A {σ}_{s}}{\sqrt{2 π u}} {e}^{- \frac{{A}^{2}}{2 {σ}_{s}^{2} {u}^{2}}} + {σ}_{s}^{2} Q ( \frac{A}{{σ}_{s} u} ) ] {\sum }_{i = 1}^{∞} {\sum }_{{k = 1 ,}_{i + k is even}}^{∞} \frac{E \{ {n}^{i + k} \} {B}^{i + k}}{i ! k !} .\end{matrix} & ( 20 )\end{matrix}$$

Since the quantization error and AWGN is usually very small, the higher order terms in equation (20) are much smaller than the first few terms, and can be neglected. The optimal coefficient u can be found by letting σ₁² equal to σ₂², and in this way the variance σ′ₙ² can be minimized.

An indication of the symbol error rate (SER) performance of the PAPR reduced MCM signal produced by the hybrid amplifier 307 is now provided. When a discrete Fourier transform is performed on r′(n), n=0, . . . N−1, the output from the kth sub-channel is as provided below.

$${D}_{k} = ( {a}_{k} - {jb}_{k} ) + \frac{1}{\sqrt{N}} {\sum }_{n = 0}^{N - 1} {n}^{′} ( n ) exp ( - j 2 k π \frac{n}{N} ) \\ for k = 0 , 1 , … \frac{N}{2} - 1 \qquad ( 21 )$$

The noise component in the output of Fourier transform can be treated as Gaussian noise since N is very large. In addition, the variance of the noise component is σ′ₙ². For rectangular signal constellations in L=2^{B}^{ₖ}, a QAM signal is equivalent to two pulse amplitude modulation (PAM) signals on quadrature carriers, each with \sqrt{L}=2^{B}^{ₖ}^{/2} signal points, and Bₖ is the number of the bits carried in the k-th. sub-carrier. Since the signals in the phase-quadrature components can be perfectly separated at the demodulator, the probability of error for QAM is easily determined from the probability of error for PAM. Specifically, the SER of the \sqrt{L}-ary PAM for the kth. subchannel can be estimated by the equation below.

$${P}_{k}^{′} ( x ) = 2 ( 1 - \frac{1}{\sqrt{L}} ) Q [ \sqrt{\frac{3}{L - 1} \frac{{P}_{s}}{{σ}_{n}^{′2}}} ] , \qquad ( 22 )$$

where Q(a) is the error function.

$$Q ( α ) = {\int }_{α}^{∞} \frac{1}{\sqrt{2 π}} {ⅇ}^{- \frac{{y}^{2}}{2}} ⅆ y \qquad ( 23 )$$

The SER for the kth. subchannel is as follows.

$${P}_{k} ( x ) \approx 4 ( 1 - \frac{1}{\sqrt{L}} ) Q [ \sqrt{\frac{3}{L - 1} \frac{{P}_{s}}{{σ}_{n}^{′2}}} ] \qquad ( 24 )$$

The total error rate can then be evaluated as

$${P}_{e} = \frac{2}{N - 2} {\sum }_{k = 1}^{\frac{N}{2} - 1} {P}_{k , e} \qquad ( 25 )$$

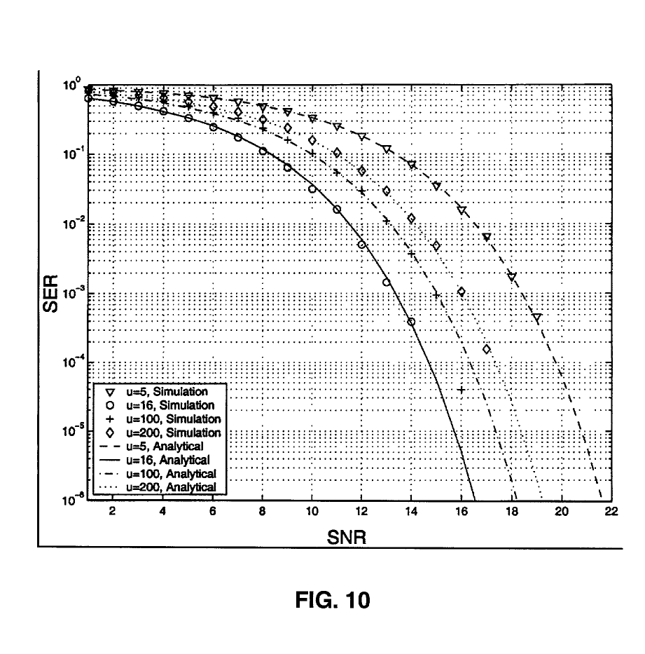

With reference to FIG. 10, the graph shows SER performance as a function of signal-to-noise ratio (SNR) before and after the PAPR reduction. The data was obtained for a 16QAM MCM system where N=256. It should be noted that the performance of the MCM system with the reduced PAPR, in accordance with the present invention, as described, is better than the prior art MCM system. This is due primarily to the increase of the transmission power by the hybrid amplifier 307. In a related simulated implementation, the improvement was largest when the coefficient is u 16. The optimal coefficient can be found by letting σ₁² equal to σ₂². By doing so, the variance σ′ₙ² can be minimized.

The spectral analysis performance of the PAPR reduced MCM signal produced by the hybrid amplifier 307 is now provided. To obtain the power spectral density (PSD) of the MCM signal after PAPR reduction, the following notation are used

s_{c1}=s_{c}(t), s_{c2}=s_{c}(t+τ) (26)

and

s₁=s(t), s₂=s(t+τ) (27)

The PSD of s_{c} is derived by evaluating the auto-correlation function Rₛ_{_{c}}ₛ_{_{c}} of the PAPR mitigated signal and then by the Fourier transformation of Rₛ_{_{c}}ₛ_{_{c}}. With the above notation, Rₛ_{_{c}}ₛ_{_{c}} can be expressed as follows.

$$\begin{matrix}{R}_{{s}_{c} {s}_{c}} = E \{ {s}_{c} ( t ) {s}_{c} ( t + τ ) \} = E \{ {s}_{c1} {s}_{c2} \} \\ = \int \int {s}_{c1} {s}_{c2} f ( {s}_{1} , {s}_{2} , ρ ) ⅆ {s}_{1} ⅆ {s}_{2}\end{matrix} \qquad ( 28 )$$

where the joint density function is given by equation the equation below.

$$\begin{matrix}f ( {s}_{1} , {s}_{2} , ρ ) = \frac{1}{2 π {σ}^{2} \sqrt{1 - {ρ}^{2} ( τ )}} exp \{ \frac{2 ρ ( τ ) {s}_{1} {s}_{2} - {s}_{1}^{2} - {s}_{2}^{2}}{2 {σ}^{2} [ 1 - {ρ}^{2} ( τ ) ]} \} \\ with & ( 29 ) \\ ρ = ρ ( τ ) = \frac{{R}_{ss} ( τ )}{{R}_{ss} ( 0 )} \\ where & ( 30 ) \\ {R}_{ss} ( τ ) = E \{ s ( t ) s ( t + τ ) \} = E \{ {s}_{1} {s}_{2} \} & ( 31 )\end{matrix}$$

Expanding the density function as a series of Hermite polynomials, the double integral can be separated and evaluated. With Mehler's formula, we have.

$$f ( {s}_{1} , {s}_{2} , ρ ) = \frac{1}{2 π {σ}^{2}} exp ( - \frac{{s}_{1}^{2} + {s}_{2}^{2}}{2 {σ}^{2}} ) {\sum }_{n = 0}^{∞} {H}_{n} ( {s}_{1} ) {H}_{n} ( {s}_{2} ) \frac{{ρ}^{n} ( τ )}{{2}^{n} n !} \qquad ( 32 )$$

where Hₙ(x) is the Hermite polynomial of n-th order. Substituting (32) into (28), we have the equation below.

$$\begin{matrix}{R}_{{s}_{c} {s}_{c}} ( τ ) = {\sum }_{n = 0}^{∞} {B}_{n} {ρ}^{n} ( τ ) \\ where & ( 33 ) \\ {B}_{n} = \frac{1}{{( 2 π )}^{n} {σ}^{2 ( n + 1 )} {2}^{n} n !} {\{ \int {s}_{cl} exp ( - \frac{{s}_{1}^{2}}{2 {σ}^{2}} ) {H}_{n} ( \frac{{s}_{1}}{\sqrt{2} σ} ) ⅆ {s}_{1} \}}^{2} & ( 34 )\end{matrix}$$

Noting that s_{c} is odd function of s and Hₙ is even function of s for n even, and is odd function of s for n odd, we have Bₙ=0, for n even. The PSD of the s_{c} can be obtained by the Fourier transformation of equation (33), with the result provided below.

$${S}_{{s}_{c} {s}_{c}} ( f ) = {\sum }_{n = 1 , 3 , 5}^{∞} \frac{1}{{( 2 π )}^{n - 1} {σ}^{2 n}} {B}_{n} {S}_{ss}^{( n )} ( f ) \qquad ( 35 )$$

where the superscript (n) denotes an n times convolution of Sₛₛ(f) with itself.

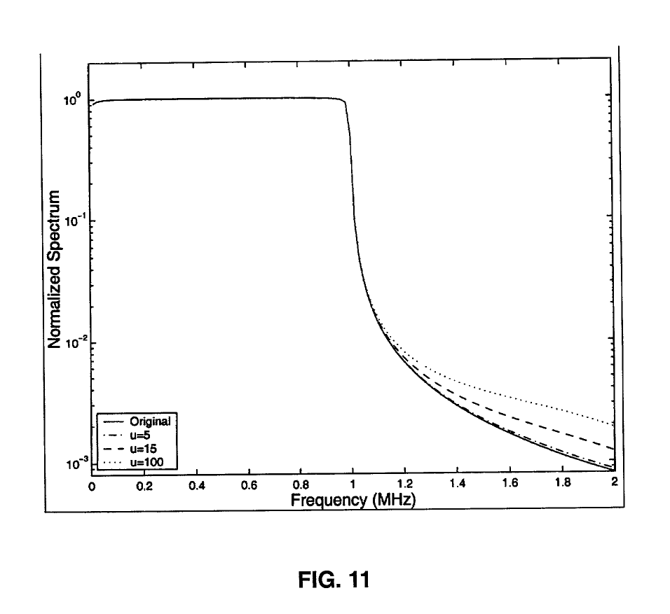

Referring now to FIG. 11, the graph shows the spectrum of s_{c}. Once Sₛₛ(f) is known, knowledge of the form of p(τ) is not required to get the spectrum of s_{c}, which appears in the steps of the derivation leading to equation (35). The graph shows that that the spectral regrowth caused by PAPR reduction is minimal and in addition, the spectral regrowth is insensitive to changes of the companding coefficient u.

The present invention, as described, provides a PAPR reducer that reduces the variation in the amplitude of a MCM signal by enhancing small amplitude MCM signals.

This is accomplished by normalizing the MCM signal and then amplifying the normalized MCM signal such that smaller amplitude portions of the MCM signal are amplified linearly and larger amplitude portions of the MCM signal are amplified non-linearly, for example, in accordance with a logarithmic function. The present invention, as described, provides a PAPR reducer that is simple to implement, and can be implemented either by real-time computation or using a look-up table. Further, no additional clipping noise is added during the PAPR reduction process and the spectral regrowth of the MCM signal after PAPR reduction is very small. In addition, the error rate performance or SER of a MCM system that incorporates a PAPR reducer in accordance the present invention, as described, is also improved.

The present invention therefore provides a method and apparatus for reducing peak to average power ratio in a multi-carrier modulation communication system which overcomes, or at least reduces the abovementioned problems of the prior art.

It will be appreciated that although only one particular embodiment of the invention has been described in detail, various modifications and improvements can be made by a person skilled in the art without departing from the scope of the present invention.

We claim:

1. A peak to average power ratio reducer for a multi-carrier modulation (MCM) communication system comprising:
a normalizer for receiving a MCM signal having a plurality of data samples, wherein the plurality of data samples represent at least a plurality of amplitude values, the normalizer for determining a maximum amplitude value from the plurality of amplitude values, and for dividing each of the plurality of amplitude values by the maximum amplitude value to produce a plurality of normalized amplitude values, and the normalizer having an output for providing a normalized MCM signal comprising a plurality of normalized data samples representing the plurality of normalized amplitude values; and
a hybrid amplifier having an input coupled to the output of the normalizer, the hybrid amplifier for receiving the plurality of normalized data samples, for comparing each of the plurality of normalized amplitude values with at least one predetermined amplitude value criteria, the hybrid amplifier for linearly amplifying the normalized amplitude values of at least some of the plurality of normalized data samples when the amplitude values of the at least some of the plurality of normalized data samples satisfy the predetermined amplitude value criteria, and the hybrid amplifier for non-linearly amplifying normalized amplitude values of some other of the plurality of normalized data samples when the normalized amplitude values of the at least some other of the plurality of normalized data samples do not satisfy the predetermined amplitude criteria, and for producing a plurality of amplified amplitude values, the hybrid amplifier having an output for providing a MCM signal comprising the plurality of amplified amplitude values.

2. A peak to average power ratio reducer in accordance with claim 1 wherein the normalizer comprises a mathematical processor for implementing equation
$$A = ( N - 2 ) \sqrt{\frac{2 {P}_{s}}{N}}$$
to determine the maximum amplitude value, where A is the maximum amplitude value, N is the number of sub-carriers in the multi-carrier modulation communication system, and Ps is the signal power of each of the sub-carriers.

3. A peak to average power ratio reducer in accordance with claim 2 wherein the normalizer comprises a memory coupled to the input for storing the plurality of data samples.

4. A peak to average power ratio reducer in accordance with claim 1 wherein the hybrid amplifier comprises a digital linear amplifier having an input for receiving the normalized amplitude values of the at least some of the plurality of normalized data samples, the digital linear amplifier for amplifying the received normalized amplitude values by a predetermined amplification factor to produce some of the plurality of amplified amplitude values.

5. A peak to average power ratio reducer in accordance with claim 4 wherein the amplification factor comprises a factor greater than unity.

6. A peak to average power ratio reducer in accordance with claim 4 wherein the hybrid amplifier comprises a digital non-linear amplifier having an input for receiving the normalized amplitude values of the at least some other of the plurality of normalized data samples, the digital non-linear amplifier for amplifying the received normalized amplitude values of the at least some other of the plurality of normalized data samples by a predetermined non-linear function to produce some other of the plurality of amplified amplitude values.

7. A peak to average power ratio reducer in accordance with claim 6 wherein the amplification function comprises a logarithmic function.

8. A peak to average power ratio reducer in accordance with claim 6 wherein the amplification function comprises a trajectory function.

9. A peak to average power ratio reducer in accordance with claim 6 wherein the hybrid amplifier comprises at least a first digital comparator being coupled to receive the normalized amplitude values of the plurality of normalized data samples, and being coupled to receive the predetermined amplitude value criteria, wherein the predetermined amplitude value criteria comprises a range of amplitude values having minimum and maximum amplitude values, and the at least the first digital comparator being coupled to the digital linear amplifier, the at least the first digital comparator for comparing each of the normalized amplitude values of the plurality of normalized data samples with the range of amplitude values, and the at least the first digital comparator being adapted to enable the digital linear amplifier when the normalized amplitude values of the at least some of the plurality of normalized data samples are received, wherein the amplitude values of the at least some of the plurality of normalized data samples are within the range of amplitude values.

10. A peak to average power ratio reducer in accordance with claim 9 wherein the hybrid amplifier comprises at least a second digital comparator being coupled to receive the normalized amplitude values of the plurality of normalized data samples, and being coupled to receive the maximum amplitude value, wherein the digital non-linear amplifier comprises a first digital non-linear amplifier module, and the at least the second digital comparator being coupled to the first digital non-linear amplifier module, the at least the second digital comparator for comparing each of the normalized amplitude values of the plurality of normalized data samples with the maximum amplitude value, and the at least the second digital comparator being adapted to enable the first digital non-linear amplifier module when the normalized amplitude values of the at least some other of the plurality of normalized data samples are received, wherein the amplitude values of the some other of the plurality of normalized data samples are greater than the maximum amplitude value.

11. A peak to average power ratio reducer in accordance with claim 10 wherein the at least the second digital comparator being coupled to the second digital non-linear amplifier module, and being coupled to receive the minimum amplitude value, the at least the second digital comparator for comparing each of the normalized amplitude values of the plurality of normalized data samples with the minimum amplitude value, and the at least the second digital comparator being adapted to enable the second digital non-linear amplifier module when the normalized amplitude values of the at least some of other of the plurality of normalized data samples are received, wherein the amplitude values of the some other of the plurality of normalized data samples are less than the minimum amplitude value.

12. A peak to average power ratio reducer in accordance with claim 11 wherein the first and second digital non-linear amplifier modules are logarithmic amplifiers.

13. A peak to average power ratio reducer in accordance with claim 11 wherein the first and second digital non-linear amplifier modules are trajectory amplifiers.

14. A peak to average power ratio reducer in accordance with claim 11 wherein the first digital non-linear amplifier module is a logarithmic amplifier, and wherein the second digital non-linear amplifier module is a trajectory amplifier.

15. A peak to average power ratio reducer in accordance with claim 11 wherein the first digital non-linear amplifier module is a trajectory amplifier, and wherein the second digital non-linear amplifier module is a logarithmic amplifier.

16. A peak to average power ratio reducer in accordance with claim 1 comprising at least one programmed digital signal processor.

17. A peak to average power ratio reducer in accordance with claim 1, wherein the normalizer comprises at least one programmed digital signal processor.

18. A peak to average power ratio reducer in accordance with claim 1, wherein the hybrid amplifier comprises at least one programmed digital signal processor.

19. A receiver for a multi-carrier modulation (MCM) communication receiver comprising:
a hybrid amplifier having an input for receiving a PAPR reduced MCM signal, the PAPR reduced MCM signal comprising a plurality of PAPR reduced data samples, wherein each of the plurality of PAPR reduced data samples comprise an amplitude value, and the hybrid amplifier having an output for providing a PAPR restored MCM signal comprising a plurality of PAPR restored data samples, wherein each of the plurality of PAPR restored data samples comprises a restored amplitude value.

20. A receiver for a multi-carrier modulation (MCM) communication receiver in accordance with claim 19, wherein the hybrid attenuator comprises a digital linear attenuator for receiving the amplitude values of the plurality of PAPR reduced data samples, the digital linear attenuator for attenuating the received amplitude values by a predetermined attenuation factor to produce some of the plurality of restored data samples having some of the restored amplitude values.

21. A receiver for a multi-carrier modulation (MCM) communication receiver in accordance with claim 20, wherein the attenuation factor comprises a factor less than unity.

22. A receiver for a multi-carrier modulation (MCM) communication receiver in accordance with claim 19, wherein the hybrid attenuator comprises a digital non-linear attenuator for receiving the amplitude values of the plurality of PAPR reduced data samples, the digital non-linear attenuator for attenuating the received amplitude values by a predetermined non-linear function to produce some other of the plurality of restored data samples having some other of the restored amplitude values.

23. A receiver for a multi-carrier modulation (MCM) communication receiver in accordance with claim 22, wherein the predetermined non-linear function comprises an inverse logarithmic function.

24. A receiver for a multi-carrier modulation (MCM) communication receiver in accordance with claim 22, wherein the predetermined non-linear function comprises an inverse trajectory function.

25. A receiver for a multi-carrier modulation (MCM) communication receiver in accordance with claim 20, wherein the hybrid attenuator comprises at least a first digital comparator being coupled to receive the amplitude values of the plurality of PAPR reduced data samples, and being coupled to receive a predetermined amplitude value criteria, wherein the predetermined amplitude value criteria comprises a range of amplitude values having minimum and maximum amplitude values, and the at least the first digital comparator being coupled to the digital linear attenuator, the at least the first digital comparator for comparing each of the amplitude values of the plurality of PAPR reduced data samples with the range of amplitude values, and the at least the first digital comparator being adapted to enable the digital linear attenuator when the amplitude values of the some of the plurality of restored data samples are received, wherein the amplitude values of the some of the plurality of PAPR reduced data samples are within the range of amplitude values.

26. A receiver for a multi-carrier modulation (MCM) communication receiver in accordance with claim 25, wherein the hybrid attenuator comprises at least a second digital comparator being coupled to receive the amplitude values of the plurality of PAPR reduced data samples, and being coupled to receive the maximum amplitude value, wherein the non-linear attenuator comprises a first digital non-linear attenuator module, and the at least the second digital comparator being coupled to the first digital non-linear attenuator module, the at least the second digital comparator for comparing each of the amplitude values of the plurality of PAPR reduced data samples with the maximum amplitude value, and the at least the second digital comparator being adapted to enable the first digital non-linear attenuator module when the amplitude values of the some other of the plurality of PAPR reduced data samples are received, wherein the amplitude values of the some other of the plurality of PAPR reduced data samples are greater than the maximum amplitude value.

27. A receiver for a multi-carrier modulation (MCM) communication receiver in accordance with claim 26, wherein the at least the second digital comparator being coupled to the second digital non-linear attenuator module, and being coupled to receive the minimum amplitude value, the at least the second digital comparator for comparing each of the amplitude values of the plurality of PAPR reduced data samples with the minimum amplitude value, and the at least the second digital comparator being adapted to enable the second digital non-linear attenuator module when the amplitude values of the some other of the plurality of PAPR reduced data samples are received, wherein the amplitude values of the some other of the plurality of PAPR reduced data samples are less than the minimum amplitude value.

28. A receiver for a multi-carrier modulation (MCM) communication receiver in accordance with claim 27, wherein the first and second digital non-linear attenuator modules are inverse logarithmic attenuators.

29. A receiver for a multi-carrier modulation (MCM) communication receiver in accordance with claim 27, wherein the first and second digital non-linear attenuator modules are inverse trajectory amplifiers.

30. A receiver for a multi-carrier modulation (MCM) communication receiver in accordance with claim 27, wherein the first digital non-linear attenuator module is an inverse logarithmic attenuator, and wherein the second digital non-linear attenuator module is an inverse trajectory attenuator.

31. A receiver for a multi-carrier modulation (MCM) communication receiver in accordance with claim 19 comprising at least one programmed digital signal processor.

32. A receiver for a multi-carrier modulation (MCM) communication receiver in accordance with claim 19 wherein the hybrid amplifier comprises a t leas t one programmed digital signal processor .

33. A method for peak to average power ratio reduction for a multi-carrier modulation transmission system, the method comprising the steps of:
a) receiving a MCM signal comprising a plurality of data sample, wherein each of the plurality of data samples represent an amplitude value;
b) normalizing each of the plurality of amplitude values with respect to a maximum amplitude value of the plurality of amplitude values to produce a plurality of normalized data samples having normalized amplitude values;
c) comparing each of the normalized amplitude values with a predetermined range of amplitude values, wherein the predetermined range comprises a maximum amplitude value and a minimum amplitude value;
d) amplifying the normalized amplitude values linearly when the normalized amplitude values are within the predetermined range of amplitude values;
e) comparing the normalized amplitude values with the maximum amplitude value;
f) amplifying the normalized amplitude values non-linearly in accordance with a first non-linear function when the normalized amplitude values are greater than the maximum amplitude value;
g) comparing the normalized amplitude values with the minimum amplitude value;
h) amplifying the normalized amplitude values non-linearly in accordance with a second non-linear function when the normalized amplitude values are less than the minimum amplitude value; and
i) providing a PAPR reduced MCM signal comprising a plurality of amplified data samples representing the linearly amplified amplitude values, and the non-linearly amplified amplitude values in accordance with the first and second non-linear functions.

34. A method in accordance with claim 33 wherein step (b) comprises the steps of:
determining the maximum amplitude value of the plurality of data samples; and
dividing the amplitude values of substantially all of the plurality of samples by the maximum amplitude value to produce the plurality of normalized data samples having normalized amplitude values.

35. A method for restoring a peak to average power ratio reduced signal for a multi-carrier modulation receiving system, the method comprising the steps of:
a) receiving a PAPR reduced MCM signal comprising a plurality of PAPR reduced data samples, wherein each of the plurality of PAPR reduced data samples represent an amplified amplitude value;
b) comparing the amplified amplitude values with a predetermined range of amplitude values, wherein the predetermined range comprises a maximum amplitude value and a minimum amplitude value;
c) attenuating the amplified amplitude values linearly when the received amplified amplitude values are within the predetermined range of amplitude values;
d) comparing the amplified amplitude values with the maximum amplitude value;
e) attenuating the amplitude value of the received amplified amplitude values non-linearly in accordance with a first non-linear function when the received amplified amplitude values are greater than the maximum amplitude value;
f) comparing the amplified amplitude values with the minimum amplitude value;
g) attenuating the amplified amplitude values non-linearly in accordance with a second non-linear function when the amplified amplitude values are less than the minimum amplitude value; and
h) providing a restored MCM signal comprising a plurality of PAPR restored data samples representing the linearly attenuated amplitude values, and the non-linearly attenuated amplitude values in accordance with the first and the second non-linear functions.
